(19) United States
(12) Patent Application Publication
(10) Pub. No.: US 2004/0207611 A1
(43) Pub. Date: Oct. 21, 2004

(54) Display apparatus

(75) Inventors: Toshinori Hirobe, Kanagawa (JP); Hirokuni Takano, Saitama (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/822,665

(22) Filed: Apr. 13, 2004

(30) Foreign Application Priority Data
Apr. 18, 2003 (JP) 2003-114173
Jun. 23, 2003 (JP) 2003-177485
Mar. 22, 2004 (JP) 2004-083439

(51) Int. Cl. G09G 5/00

(52) U.S. Cl. 345/204

(57) ABSTRACT

For the purpose of a presenter performs presentation without obstructing an image display section, a display apparatus is provided with switches having the same function are arranged on a left side and a right side of the image display section.

### BACKGROUND OF THE INVENTION

1. Field of the Invention

The present invention relates to a display apparatus having switches.

2. Related Background Art

Up to now, as a display apparatus including an image display section of a large screen, there are various ones such as a rear projection display, a liquid crystal display, and a plasma display.

FIG. 1 is a front view showing an example of a structure of such a display apparatus. Reference character D3 denotes the display apparatus. Reference numeral 1 denotes an image display section; 10, a housing; 11, a support base; and 320, a switch group. Reference numerals 321 to 326 denote switches, respectively, which are provided for each objective function. In some display apparatuses, the switches 321, etc. are provided beside the image display section 1 such that software displayed on a screen is operated and a displayed image is switched by such switches.

Incidentally, such a display apparatus may be used for presentation. In that case, a presenter C1 generally performs presentation while standing at a left end or a right end of an image display section so as not to obstruct an image (see FIG. 2).

However, in the case in which the switches 321, etc. are arranged only on one side of the image display section 1 (see FIG. 1), there is a problem in that, although no specific trouble occurs if the presenter stands in the vicinity of the switches as shown in FIG. 2, an image disappears from sight when the presenter attempts to operate the switches 321, etc. if the presenter stands on the opposite side (a side where the switches 321, etc. are not arranged) (see FIG. 3).

In addition, in the case of a display apparatus D4 in which switches 331, etc. are arranged in a central part thereof as shown in FIG. 4, there is a problem in that an image is obstructed when a presenter operates the switches from a right side or a left side of the display apparatus.

On the other hand, such a display apparatus is used not only for presentation but also for information display in public facilities such as a station. When switches are arranged only in one part as shown in FIGS. 1 and 4, it is likely that operability is deteriorated and, to make matters worse, the image display section 1 is obstructed frequently.

### SUMMARY OF THE INVENTION

Thus, it is an object of the present invention to provide a display apparatus which reduces obstructions to an image.

Accordingly, the present invention provides a display apparatus including: an image display section, a housing for supporting the image display section, and a switch arranged in the housing, wherein a display apparatus includes the plurality of switches, and wherein the plurality of switches have the same function as one another and are arranged on a left side and a right side with respect to the image display section.

### BRIEF DESCRIPTION OF THE DRAWINGS

FIG. 1 is a front view showing an example of a structure of a display apparatus in which switches are arranged on one side;

FIG. 2 is a front view showing an example of the use state of the display apparatus in which the switches are arranged on one side;

FIG. 3 is a schematic diagram for explaining problems of the display apparatus in which the switches are arranged on one side;

FIG. 4 is a front view showing another example of the structure of the display apparatus in which the switches are arranged on one side;

FIG. 5 is a schematic diagram showing a display apparatus in accordance with a first embodiment of the present invention;

FIG. 6 is a flowchart in accordance with the first embodiment of the present invention;

FIG. 7 is a schematic diagram showing another display apparatus in accordance with the first embodiment of the present invention;

FIG. 8 is a schematic diagram showing another display apparatus in accordance with the first embodiment of the present invention;

FIG. 9 is a schematic diagram showing a display apparatus in accordance with a second embodiment of the present invention;

FIG. 10 is another schematic diagram showing the display apparatus in accordance with the second embodiment of the present invention;

FIG. 11 is a schematic diagram showing sensor ranges of object sensors of the display apparatus in accordance with the second embodiment of the present invention;

FIG. 12 is a schematic diagram of the object sensor;

FIG. 13 is a flowchart showing a state of lighting control for a left side switch;

FIG. 14 is a flowchart showing a state of lighting control for a right side switch;

FIG. 15 is a flowchart showing a state of lighting control for the left side switch;

FIG. 16 is a flowchart showing a state of lighting control for the right side switch;

FIG. 17 is a flowchart for explaining an action of an information processing apparatus;

FIG. 18 is a flowchart showing a state of lighting control for the left side switch;

FIG. 19 is a schematic diagram for explaining a function of each switch;

FIG. 20 is a schematic diagram showing another display apparatus in accordance with the second embodiment of the present invention;

FIG. 21 is a schematic diagram showing sensor ranges of object sensors included in the display apparatus of FIG. 20;

FIG. 22 is comprised of FIGS. 22A and 22B showing flowcharts of a state of lighting control for the left side switch;

FIG. 23 is comprised of FIGS. 23A and 23B showing flowcharts of a state of lighting control for the right side switch; and

FIG. 24 is a schematic diagram showing a state in which sensor ranges of object sensors overlap each other.

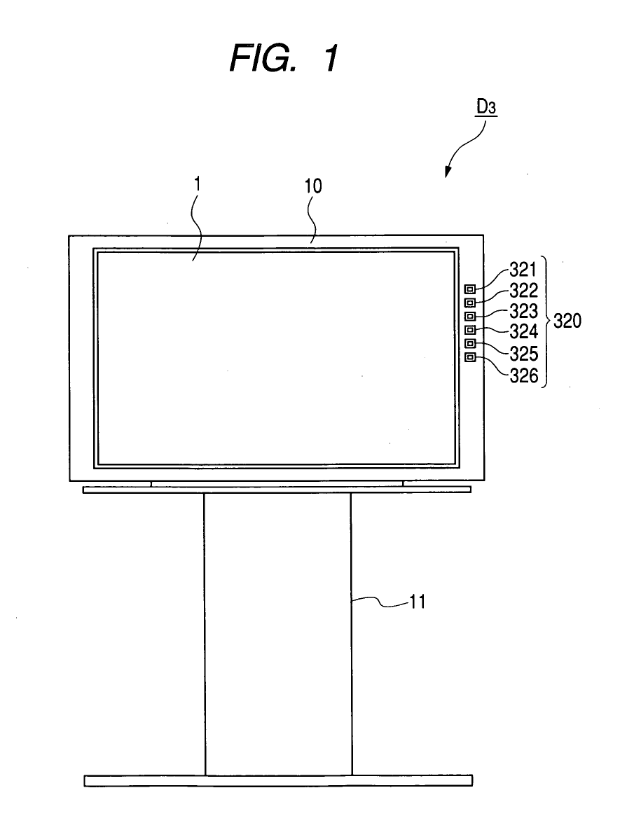

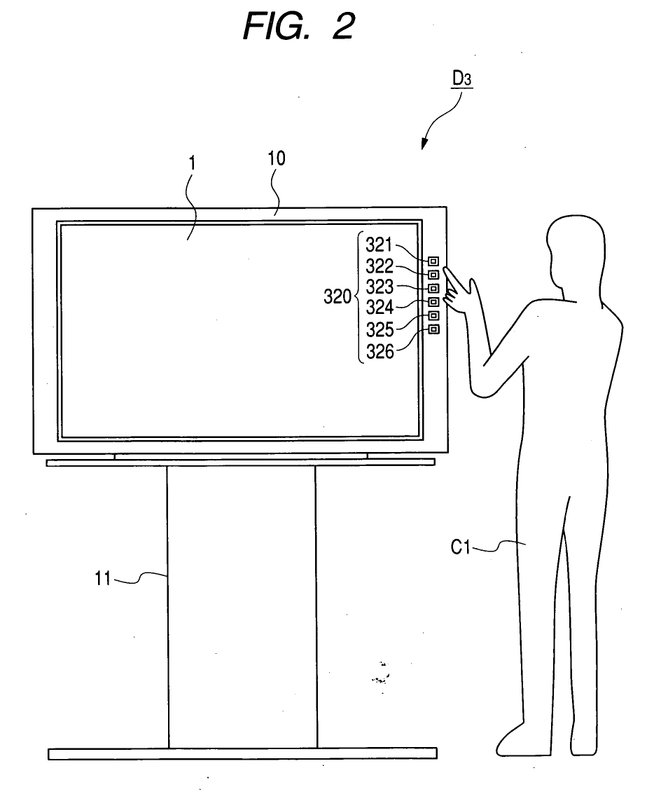

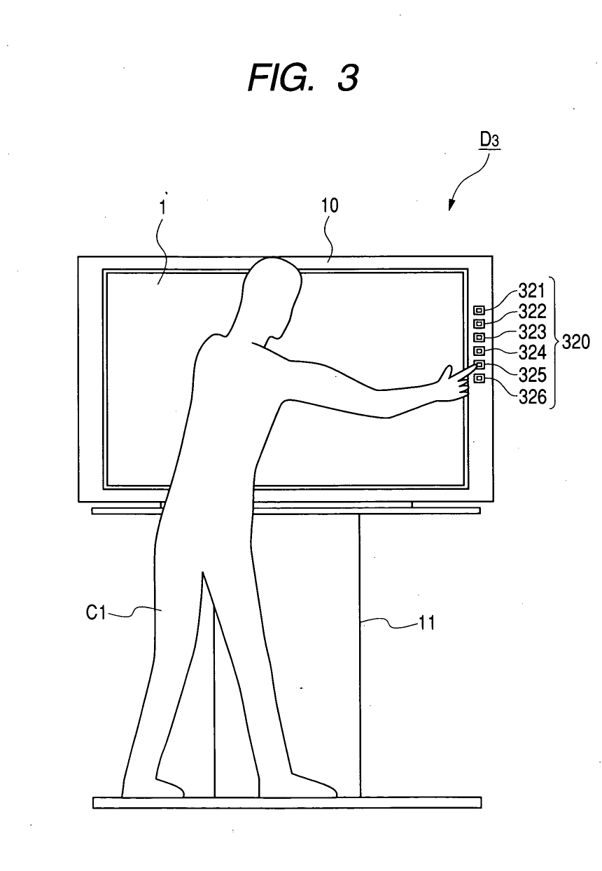

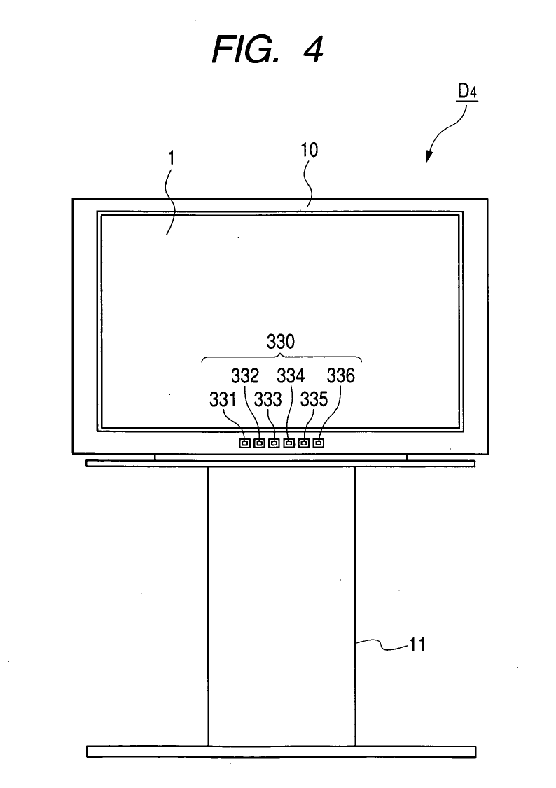

### DESCRIPTION OF THE PREFERRED EMBODIMENTS

A display apparatus of the present invention is characterized in that switches having the same function are arranged on the left and the right with respect to an image display section. The left and the right with respect to the image display section mean the left and the right in the case in which the image display section is viewed from the front. In other words, this means that the image display section has left and right ends, and the left and the right with respect to the image display section are the left and the right in the case in which a position equidistant from both the ends is set as a center. Therefore, the left and the right do not mean positions in a vertical direction with respect to the image display section of the image display apparatus. More specifically, the switches may be arranged on a lower side of the image display section or may be arranged on an upper side thereof, respectively. In addition, the switches may be arranged outside the image display section and anywhere between an upper end and a lower end of the image display section.

Further, the switches may be arranged in a housing. The housing means a member which functions as a frame supporting the image display section. More specifically, it is preferable that the switches are arranged in this housing because a screen (image display section) is not obstructed and because operability and miniaturization of the display apparatus are improved. As a shape of the housing, it is preferable that the housing is formed so as to surround sides of the image display section when the image display section is observed from the front. In that case, the switches may be arranged in positions surrounding the sides of the image display section, that is, on a surface where the switches can be observed together with the image display section when the image display section is observed from the front. In this case, since the switches and the image display section are arranged on the same side, the display apparatus can be arranged with a side other than that side (e.g., a side portion) placed close to a wall or the like. Alternatively, although a side surface of the housing cannot be observed in the case in which the image display section is observed from the front, the switches may be arranged on the side surface of the housing. In that case, the switch section is not seen from a person observing the image display section.

In addition, the display apparatus of the present invention may further include the plurality of switches for each of different functions.

Incidentally, the display apparatus preferably includes an object sensor. This object sensor is a sensor for sensing a position of a presenter, and lights of switches can be turned on at a side where the presenter can easily operate the switches by judging means on the basis of a result of sensing by the sensor. As a result, the presenter can perform presentation without any trouble in finding a position of a switch. Moreover, the display apparatus is preferable, for example, in the case in which a room is darkened for presentation.

The display apparatus may include one object sensor or a plurality of object sensors as long as a position of a presenter can be grasped.

Embodiments of the present invention will be hereinafter described in more detail.

### First Embodiment

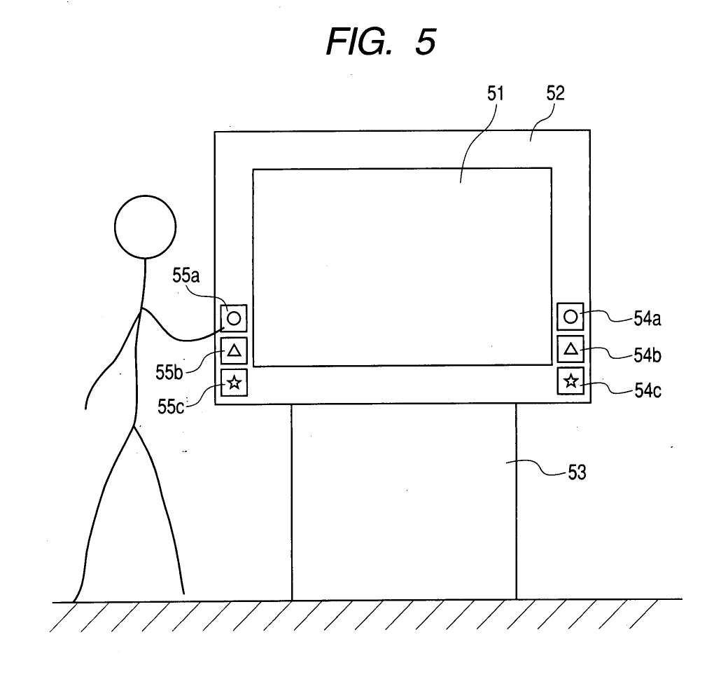

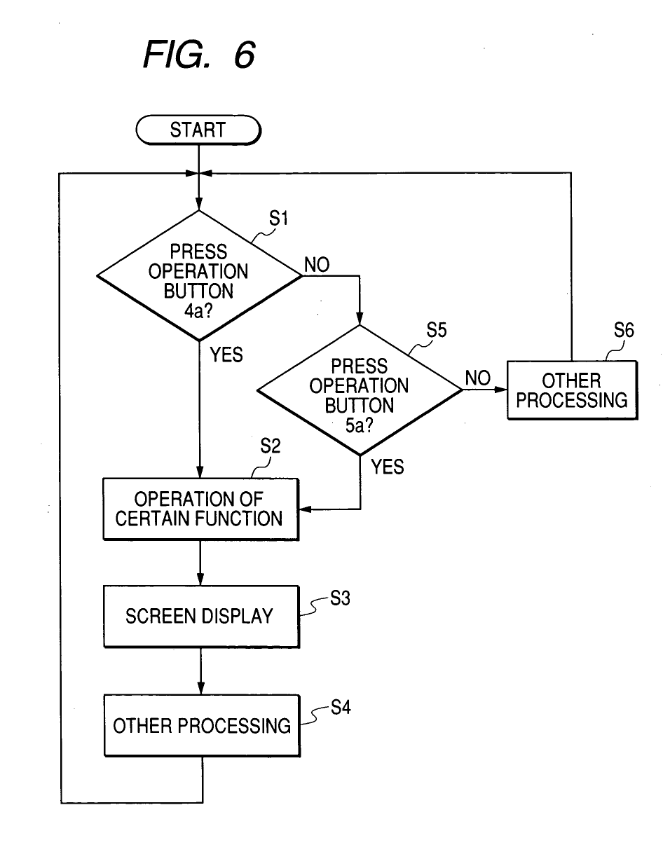

FIG. 5 is an explanatory diagram according to the present invention, and FIG. 6 is a flowchart explaining the present invention.

In FIG. 5, reference numeral 51 denotes a display section (image display section) of a screen; 52, a housing section in an upper part of an image display apparatus; 53, a housing section (support member) in a lower part of the image display apparatus; and 54a, 54b, 54c, 55a, 55b and 55c, operation buttons (a switch group) for controlling functions.

The operation button 54a and the operation button 55a serve to control the same function.

The same applies to the operation button 54b and the operation button 55b as well as the operation button 54c and the operation button 55c. In other words, a plurality of switches with the same function are arranged and, for each of different functions, a plurality of switches are arranged.

The first embodiment will be described on the basis of the above-mentioned structure. First, a presenter and an explainer stands on one side of an image display apparatus of a large screen (the left side of the screen 51 in the figure) and performs presentation and explain contents of the screen. In this case, the presenter must properly show the screen to people listening to the presentation and pay attention so that a visual field of the screen is not obstructed by a part of a body of the presenter. As the explanation progresses, it becomes necessary to change a screen display (e.g., page scrolling).

For example, when it is assumed that the operations buttons 55a and 54a are allocated for a function of page scrolling, the presenter can press the operation button 55a to carry out an operation of page scrolling without obstructing the screen 51 while staying in the present position (the left side of the screen 51 in the figure). In addition, if the presenter wishes to carry out the operation of page scrolling when the presenter stands on the right side of the screen 51 (not shown in the figure) and explains the contents displayed on the screen, the presenter can executes the operation by pressing the operation button 54a without obstructing the screen 51 with a part of the body.

Next, in a flowchart of FIG. 6, first, the image display apparatus judges whether or not the presenter has pressed the operation button 54a (step S1). If the operation button 54a has been pressed, a function corresponding to the pressed operation button 54a operates (step S2), and an image is displayed on the screen 51 (step S3). Thereafter, the image display apparatus shifts the processing to other processing (step S4) and returns the processing to step S1. In addition, if the operation button 54a has not been pressed in step S1, the image display apparatus judges whether or not the presenter has pressed the operation button 55a (step S5). If the operation button 55a has not been pressed, the image display apparatus performs other processing (step S6) and returns the processing to step S1. If the operation button 55a has been pressed, a function corresponding to the pressed operation button 55a (in this case, functions of the operation button 54a and the operation button 55a are the same) operates (step S2), and an image is displayed on the screen 51 (step S3). Thereafter, the image display apparatus shifts the processing to other processing (step S4) and returns the processing to step S1 again.

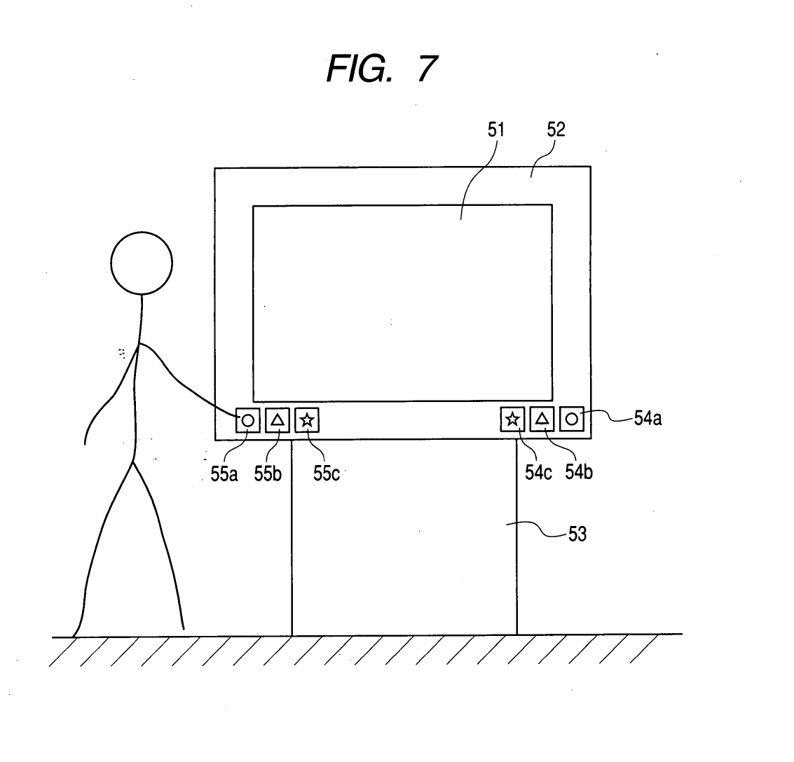

FIG. 7 is another explanatory diagram illustrating this embodiment.

A display apparatus shown in FIG. 7 is different from the display apparatus shown in FIG. 5 in that operation buttons are arranged on the left and the right on a lower surface of the screen 51.

In this case, a presenter can also touch the operation buttons without obstructing the screen 51 with a body or the like of the presenter during presentation.

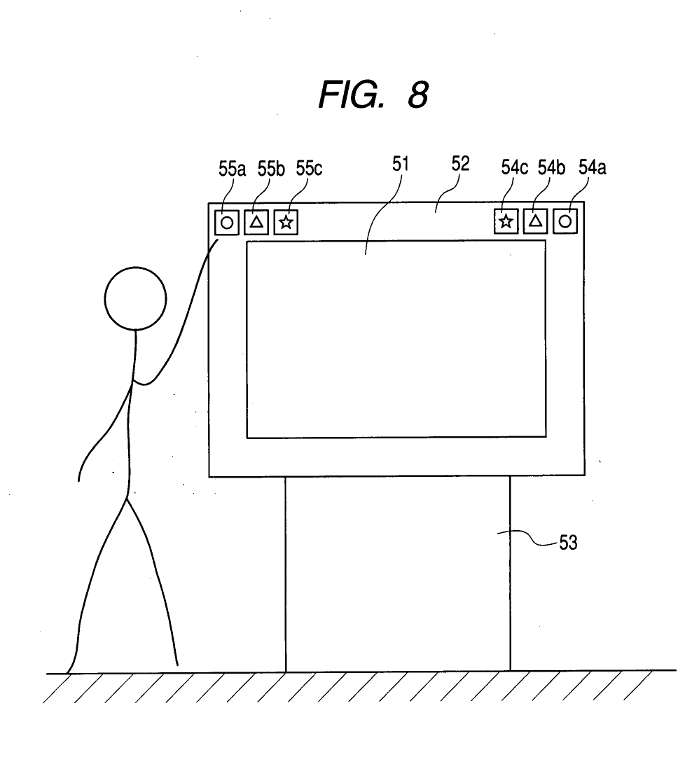

FIG. 8 is still another explanatory diagram illustrating this embodiment.

A display apparatus shown in FIG. 8 is different from the display apparatus shown in FIG. 5 in that operation buttons are arranged on the left and the right on an upper surface of the screen 51.

In this case, a presenter can also touch the operation buttons without obstructing the screen 51 with a body or the like of the presenter during presentation.

As described above, according to this embodiment, two or more operation buttons, which cause one function to operate, are provided and arranged in positions where a presenter or an explainer does not obstruct a screen from the left and the right with a hand, an arm, a body or the like when the presenter or the explainer stands on one side of a display apparatus to operate the operation buttons. Consequently, an image display apparatus can be provided with which a screen is not obstructed by the body or the like of the presenter even if the presenter stands beside the screen for the explanation and attempts to operate the operation buttons set in the apparatus.

### Second Embodiment

A display apparatus in accordance with this embodiment is characterized by including object sensors (sensing means).

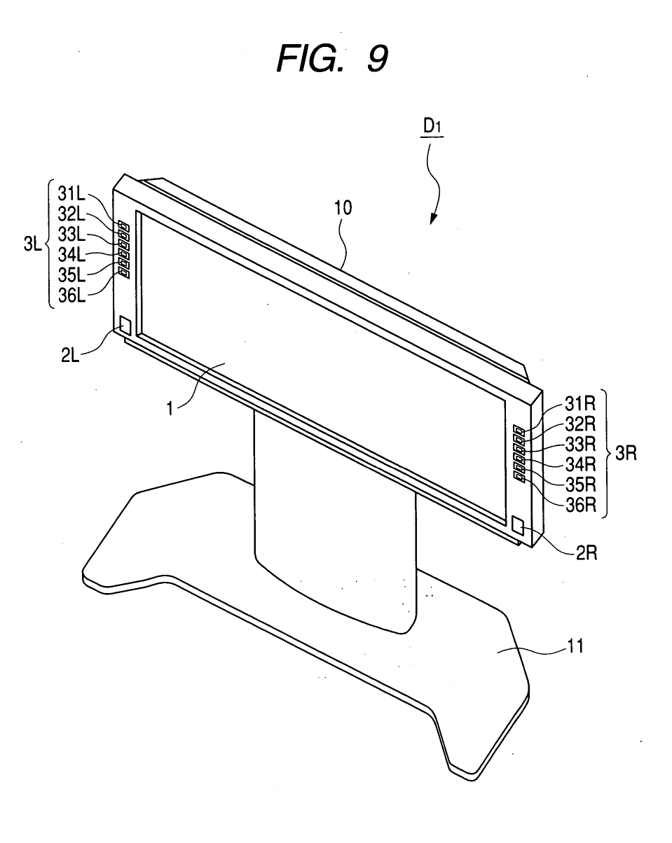

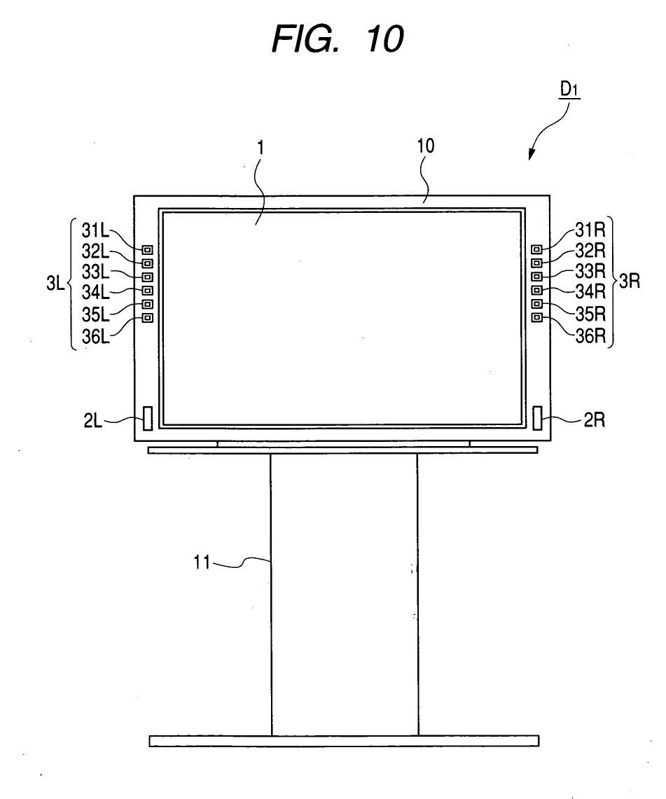

The display apparatus in accordance with this embodiment is denoted by reference symbol D₁ in FIGS. 9 and 10. Reference numeral 10 denotes a housing; 2L and 2R, object sensors (more specifically, human body sensing means), respectively; 11, a support base; and 3L and 3R, switch groups. The display apparatus in accordance with this embodiment includes an image display section 1 which displays an image; and switches 31L, 32L, 33L, etc. and switches 31R, 32R, 33R, etc. for executing various operations. The switches 31L, 32L, 33L, etc. and the switches 31R, 32R, 33R, etc. are arranged on the left side and the right side with respect to the image display section 1, respectively. At least principal operations can be executed by both the switches on the left side and the switches on the right side. Here, the notion that “at least principal operations can be executed by both the switches on the left side and the switches on the right side” is a concept including not only

a case in which the same operations can be executed by all the switches of the left side switch group 3L and all the switches of the right side switch group 3R, but also

a case in which only a part of the switches of the left side switch group 3 L (e.g., three switches 31L, 32L and 33L) and a part of the switches of the right side switch group 3R (e.g., three switches 31R, 32R and 33R) can execute the same operations. Therefore,

the remaining left side switches 3 L, etc. and the remaining right side switches 34R, etc. may not execute the same operations, and

the left side switches 31L, 32L, 33L, etc. and the right side switches 31R, 32R, 33R, etc. may not be provided in the same number and may not be arranged in symmetrical positions. Note that the switches 31L, 32L, 33L, etc. and the switches 31R, 32R, 33R, etc. are switches of a self-luminous type.

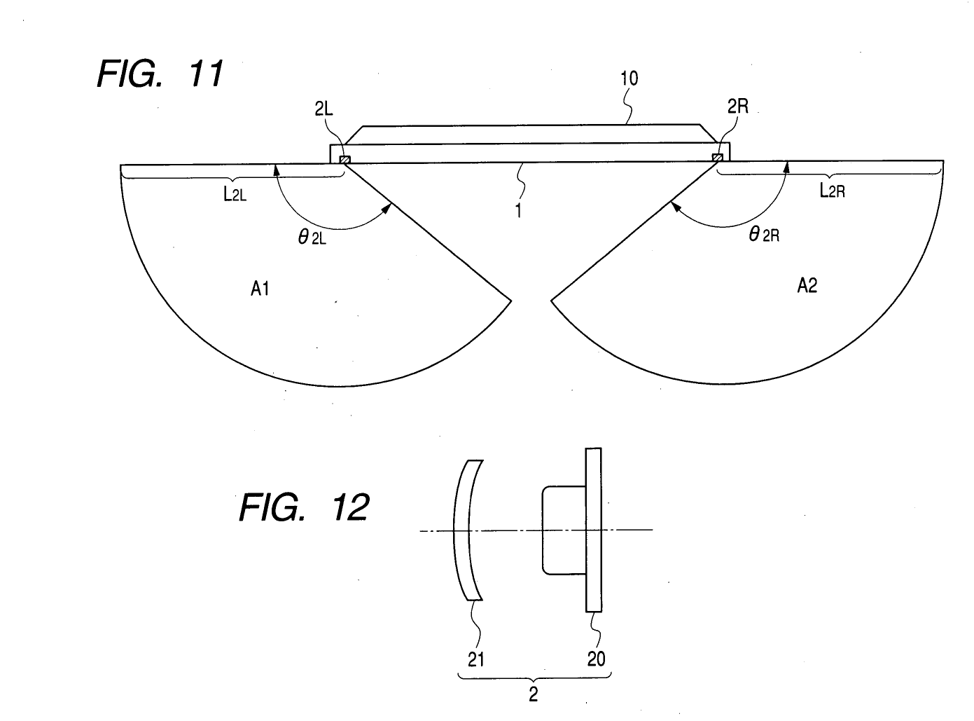

In addition, FIG. 11 is a schematic diagram illustrating a display apparatus from a vertical direction in order to explain areas which can be sensed by the human body sensing means (hereinafter also represented as “human body sensor”) included in the display apparatus in accordance with this embodiment. The display apparatus D₁ includes human sensing means 2L and 2R which sense whether or not a person exists in an area in the vicinity of the left side switches 31L, 32L, 33L, etc. (i.e., an area indicated by reference character A1 in FIG. 11) or an area in the vicinity of the right side switches 31R, 32R, 33R, etc. (i.e., an area indicated by reference character A2 in FIG. 11); and a lighting control unit (not shown) which receives signals from the human body sensing means 2L and 2R and controls lighting of the switches 31L, 32L, 33L, etc. and the switches 31R, 32R, 33R, etc. The lighting control unit is adapted to turn on lights of the switches 31L, 32L, 33L, etc. or the switches 31R, 32R, 33R, etc. on a side where existence of a person has been sensed.

The lighting control unit is a section which

turns on lights of the left side switches 31L, etc. in the case in which the human body sensing means 2L has sensed that a person exists in the area A1 of the vicinity of the left side switches, and ‘turns on lights of the right side switches 31R, etc. in the case in which the human body sensing means 2R has sensed that a person exists in the area A2 of the vicinity of the right side switches. In this case, it is unnecessary to turn on the lights of all the left side switches 31L, etc. (or all the right side switches 31R, etc.), and it is also possible that an operating state of the display apparatus is judged and, then, only lights of necessary switches are selectively turned on. Note that it is advisable that the lighting control unit brings the switches 31L, etc. or the switches 31R, etc. on a side, where existence of a person has not been sensed, into a turned-off state or a darkened state.

On the other hand, it is advisable to constitute the human body sensing means 2L and 2R with a plurality of human body sensors, which sense presence or absence of a person, for example,

a left side human body sensor 2L which senses whether or not a person exists in the area A1 of the vicinity of the left side switch, and

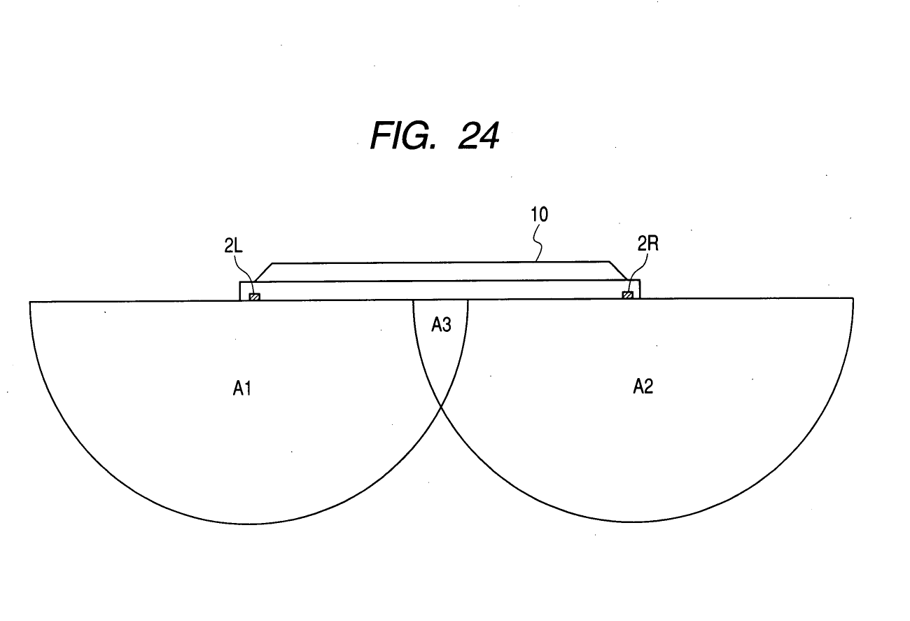

a right side human body sensor 2R which senses whether or not a person exists in the area A2 of the vicinity of the right side switch. Note that the human body sensors 2L and 2R are arranged in symmetrical positions in FIG. 9. However, it is needless to mention that positions of the human body sensors 2L and 2R are not limited to this. In addition, sensors with the same structure (e.g., pyroelectric infrared ray sensors) or sensors with different structures may be used as the left and right human body sensors 2L and 2R. A plurality of sensors using different sensing methods may be used in combination. Moreover, the sensing areas A1 and A2 shown in FIG. 11 are set so as not to overlap with each other. However, the sensing areas A1 and A2 may be set so as to overlap with each other (see reference character A3 in FIG. 24). In this case, if a person is sensed in the overlapping area, the control unit only has to instruct the lights of both the switch groups 3L and 3R to be turned on. In addition, it is also possible that a sensing area of the human body sensing means can be changed.

It is advisable that an information processing apparatus is connected to the display apparatus to display software, which is executed by the information processing apparatus, on the image display section 1, and the software can be operated by the switches 31L, etc. and the switches 31R, etc. It is advisable that the control unit turns on lights of only switches necessary for execution of the software.

Next, an effect of this embodiment will be described.

According to this embodiment, the switches 31L, etc. and the switches 31R, etc. are arranged on both the left side and the right side of the image display section 1, respectively. Principal operations of the switches can be executed only by the left side switches 31L, etc. or only by the right side switches 31R, etc. Therefore, in the case in which a presenter performs presentation or the like using this display apparatus in the presence of others, the presenter only has to operate the switches 31L, etc. or the switches 31R, etc. closer to the presenter whether the presenter stands on the left side or the right side of the image display section 1. The presenter can be prevented from obstructing an image. In addition, in the case in which there are a plurality of persons (an operator and a presenter), the operator only has to operate the switch group on a side close to the operator. It becomes possible to reduce the risk that the operator may obstruct the image display section 1.

Incidentally, according to this embodiment, the switches are provided on both the left side and the right side of the display apparatus for principal operations, and the number of switches is accordingly increased. Thus, it is likely that the switches are conspicuous excessively when people watch the image display section 1. However, such a problem can be avoided by making the switches themselves as less conspicuous as possible (e.g., the switches are colored in the same color as the apparatus housing, and their unevenness is made less conspicuous), and adapting the display apparatus to turn on lights of only operable switches to bring the other switches into a turned-off state or a darkened state.

In addition, in the case in which this display apparatus is used as various information displays which are operated by unspecified large number of operators in public facilities and the like, if an operator is unaccustomed to an operation of the apparatus, it is likely that, when the number of switches has increased, it becomes hard for the operator to understand which switch should be operated, and the operator is confused. However, in the present invention, since the light of the switch group on a side where no operator exists is turned off or deadened, it becomes possible to spare the operator the confusion.

The following examples will be hereinafter described in more detail in accordance with the present embodiments.

### EXAMPLE 1

In this example, a flat panel display apparatus of a structure shown in FIGS. 9 and 10 was manufactured.

That is, the switches 31L, 32L, 33L, etc. and the switches 31R, 32R, 33R, etc. were arranged on both the left side and the right side of the image display section 1 of a large screen, respectively, such that the same operation (an operation for software or a displayed image switching operation) could be executed only by the left side switches 31L, 32L, 33L, etc. or only by the right side switches 31R, 32R, 33R, etc. Further, the human body sensors 2L and 2R were arranged below the switches 31L, etc. and the switches 31R, etc., respectively, so as to sense whether or not a person existed in the areas denoted by reference characters A1 and A2 in FIG. 11. Here, FIG. 11 is a plan view showing the sensing areas of the left side human body sensor 2L and the right side human body sensor 2R in this example. The left side human body sensor 2L was constituted so as to sense a fan-shaped area with a central angle θ_{2L} and a radius L_{2L}, and the right side human body sensor 2R was constituted so as to sense a fan-shaped area with a central angle θ_{2R} and a radius L_{2R}. A switch incorporating illumination means of self-luminous type was used as the switches 31L, etc. and the switches 31R, etc. The human body sensors 2L and 2R were connected to the switches via a lighting control unit (not shown). As a result, if a person exists on the right side of the image display section 1, the right side human body sensor 2R, which has sensed the existence of the person, sends a signal to the control unit, and the control unit turns on lights of the right side switches 31R, etc. In addition, if a person exists on the left side of the image display section 1, the left side human body sensor 2L, which has sensed the existence of the person, sends a signal to the control unit, and the control unit turns on the lights the left side switches 31L, etc. (details will be described later).

As shown in FIG. 12, the human body sensors 2L and 2R were constituted of a pyroelectric infrared ray sensor 20 and a Fresnel lens 21 for determining a sensing distance and a sensing range of the pyroelectric infrared ray sensor 20 (the Fresnel lens 21 was designed optically such that, when a person entered a desired range, the pyroelectric infrared ray sensor 20 could sense the entrance of the person).

Note that reference numeral 10 of FIGS. 9 and 10 denotes the housing of the image display section 1, and reference numeral 11 denotes the support base of the image display section 1.

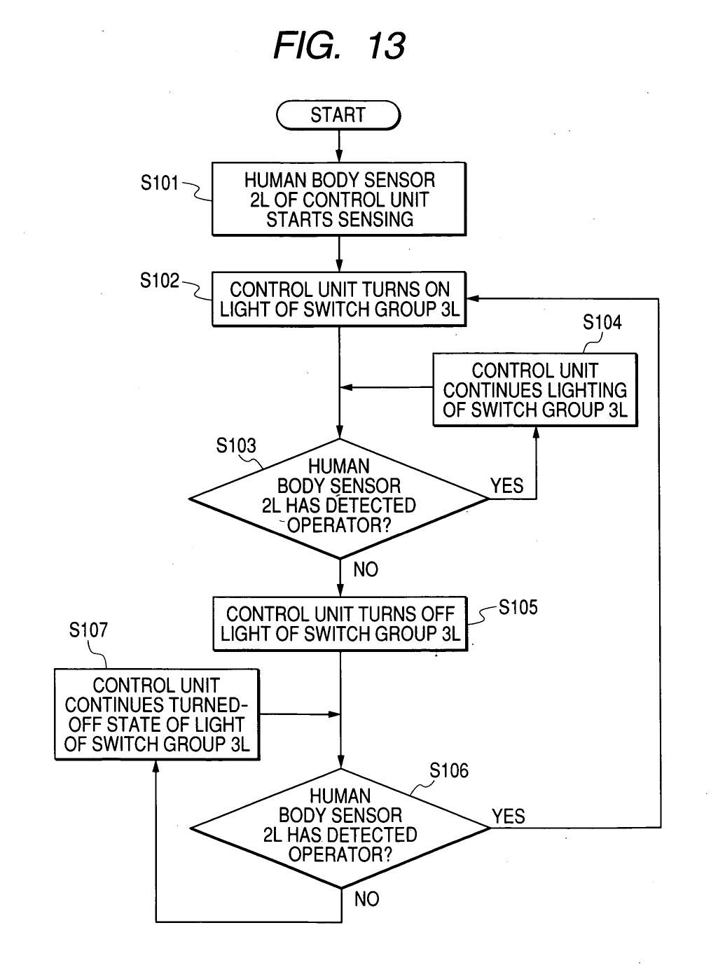

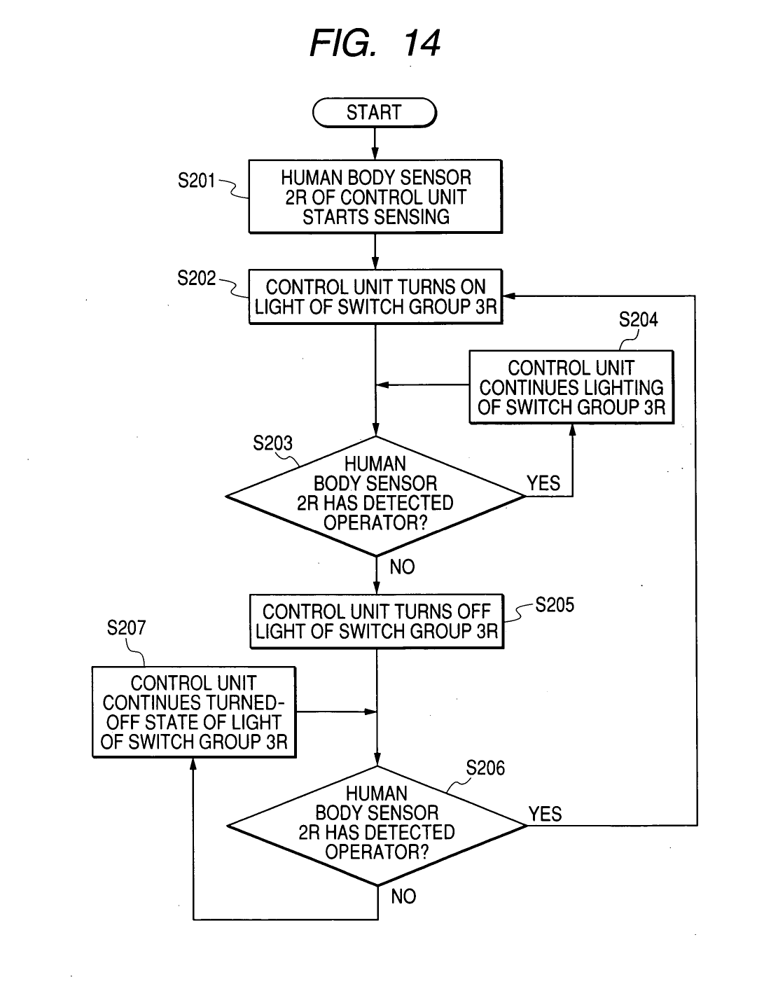

Lighting control for the left switches 31L, etc. and the right switches 31R, etc. will be hereinafter described in accordance with FIGS. 13 and 14.

After power-on of the apparatus, the left side human body sensor 2L starts sensing in the sensing area A1 (S01), and the control unit turns on a light of the left side switch group 3L (regardless of presence or absence of a person) (S102). Then, when the left side human body sensor 2L has sensed a person, the control unit continues lighting of the left side switch group 3L (S103, S104). If the left side human body sensor 2L has not sensed a person, the control unit turns off the light of the left side switch group 3L (S103, S105). Then, this turned-off state is maintained until the left side human body sensor 2L senses a person (S106, S107). The same control is performed for the right side switches 31R, etc (see FIG. 14).

According to this example, the switches 31L, etc. and the switches 31R, etc. are arranged on both the left side and the right side of the image display section 1, respectively, such that the same operation can be executed by both the left side switches 31L, etc. and the right side switches 31R, etc. Therefore, in the case in which presentation or the like is performed in the presence of others using this display apparatus, a presenter (operator of the display apparatus) only has to operate the switches near the operator (either the switches 31L, etc. or the switches 31R, etc.) whether the presenter stands on the left side or the right side of the image display section 1. The presenter can be prevented from obstructing an image.

### EXAMPLE 2

In this example, lighting control for switches was performed as shown in a right side column of Table 1 below. A control method for the other parts and a structure of the display apparatus itself were set to be the same as those in Example 1.

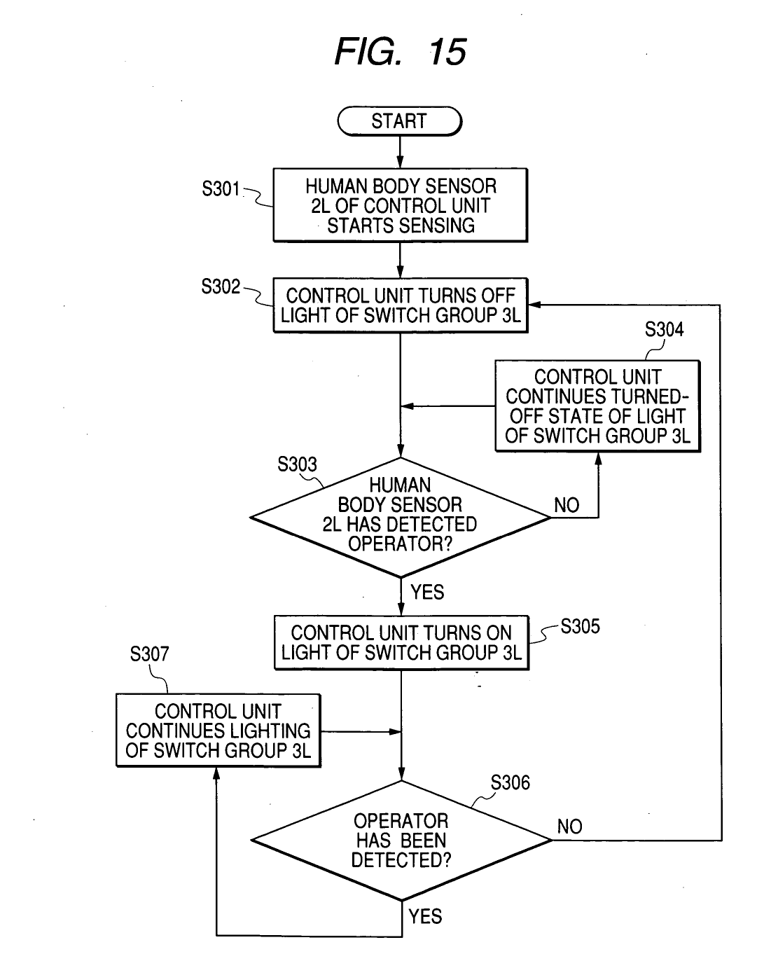

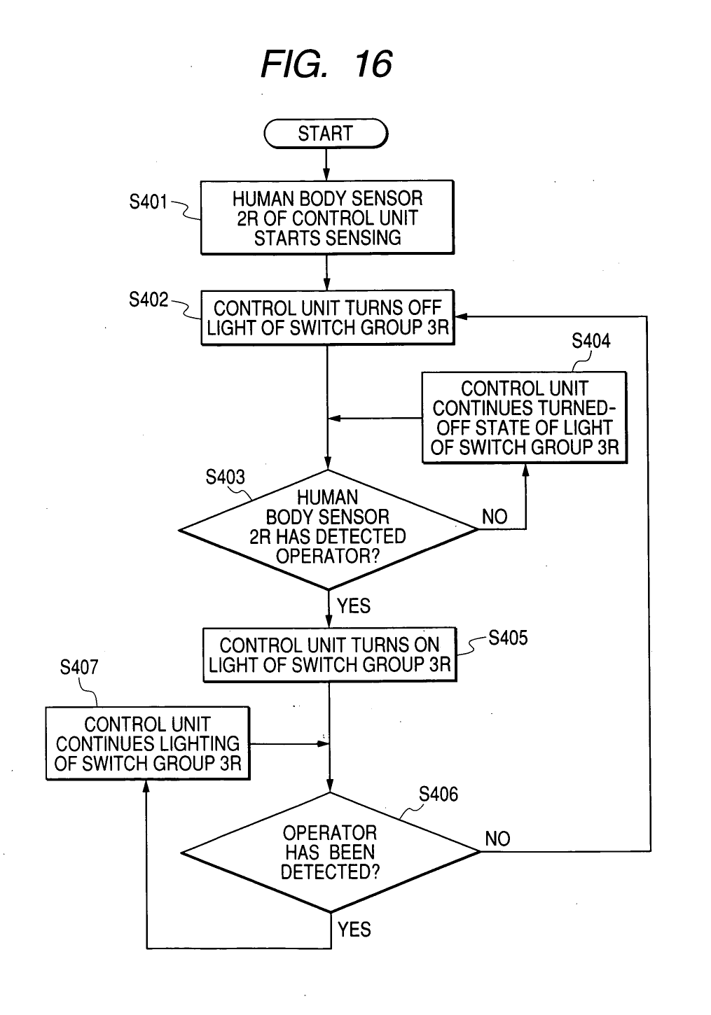

TABLE 1

| Example 1 | Example 2 |
|---|---|
| Immediately after power- | Immediately after power- |
| on; Turn on light | on; Turn on light whether |
| whether person exists or | person exists or not |
| not | (see S302 of FIG. 15 and |
| (see S102 of FIG. 13 and | S402 of FIG. 16) |
| S202 of FIG. 14) | |
| Continue lighting when | Continue lighting when |
| sensor has sensed person | sensor has sensed person |
| (see S104 of FIG. 13 and | (see S305 of FIG. 15 and |
| S204 of FIG. 14) | S405 of FIG. 16) |
| Turn off light when | Turn off light when |
| sensor has not sensed | sensor has not sensed |
| person | person |
| (see S105 of FIG. 13 and | (see S304 of FIG. 15 and |
| S205 of FIG. 14) | S404 of FIG. 16) |

According to this example, in addition to the effect in Example 1, if the human body sensor is set so as to transmit a signal to the control unit only when the human body sensor has sensed a person, it is sufficient only to cut off connection between the control unit and the human body sensor when it is not intended to turn on the switched, and a structure can be simplified.

### EXAMPLE 3

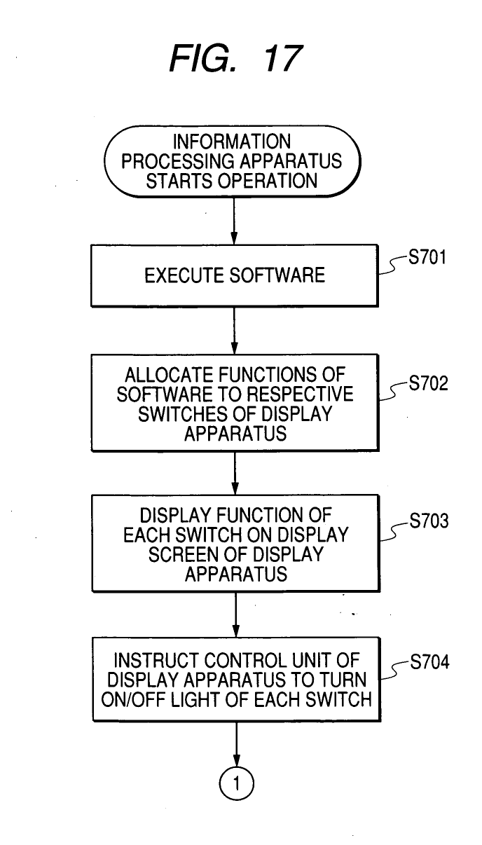

In this example, an information processing apparatus was connected to the display apparatus shown in FIGS. 9 and 10 such that software, which was executed by the information processing apparatus, was displayed on the image display section 1. Further, an instruction from the information processing apparatus was inputted to a control unit of the display apparatus, and switches of the display apparatus were allocated as operating sections, which operated the software of the information processing apparatus, by the control unit, respectively. Therefore, when an operator operates the switches, a signal is transmitted to the information processing apparatus through the control unit, and the software can be operated. This point will be described with reference to FIGS. 17 to 19.

Now, when the information processing apparatus executes the software (S701 in FIG. 17), the control unit allocates functions for operating the software, which is run by the information processing apparatus, to left side switches 31L to 36L and right side switches 31R to 36R (S702). Here, the left side switch 31L and the right side switch 31R have the same function. The same function is similarly allocated to both the switches 32L and 32R, and the same is applied to the other switches, for example, both the 36L and 36R switches have the same function.

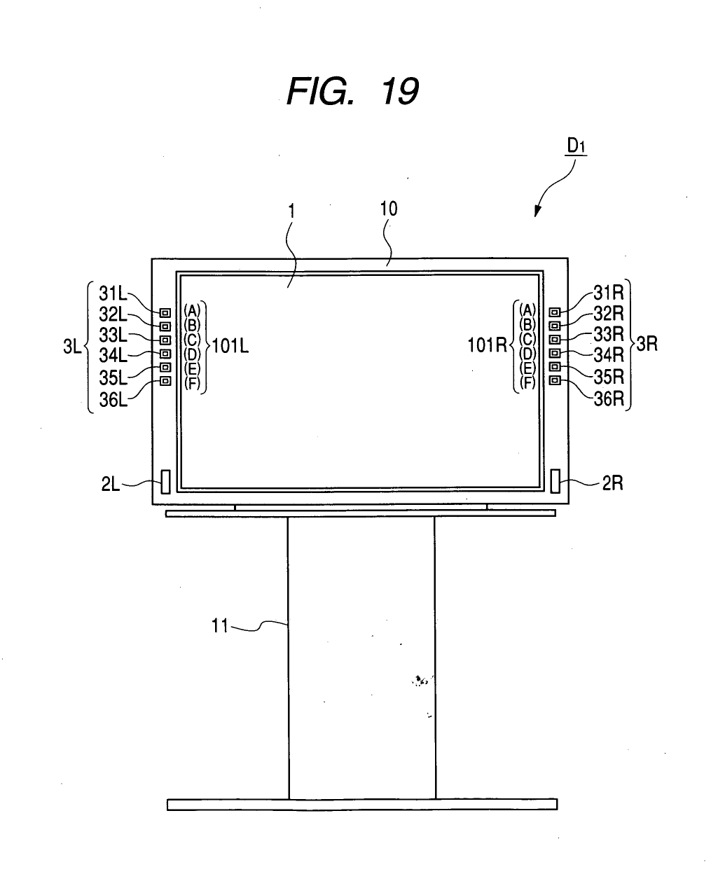

Moreover, the information processing apparatus displays a function of each switch on a display screen of the display apparatus (S703). More specifically, as indicated by reference characters 101L and 101R in FIG. 19, the respective functions are displayed in parts corresponding to the respective switches. Here, when the information processing apparatus allocates functions to the respective switches, if there is a switch not to be used, the information processing apparatus gives an instruction to turn on only a light of a switch to be used, or to turn off or deaden a light of the switch not to be used (S704 in FIG. 17).

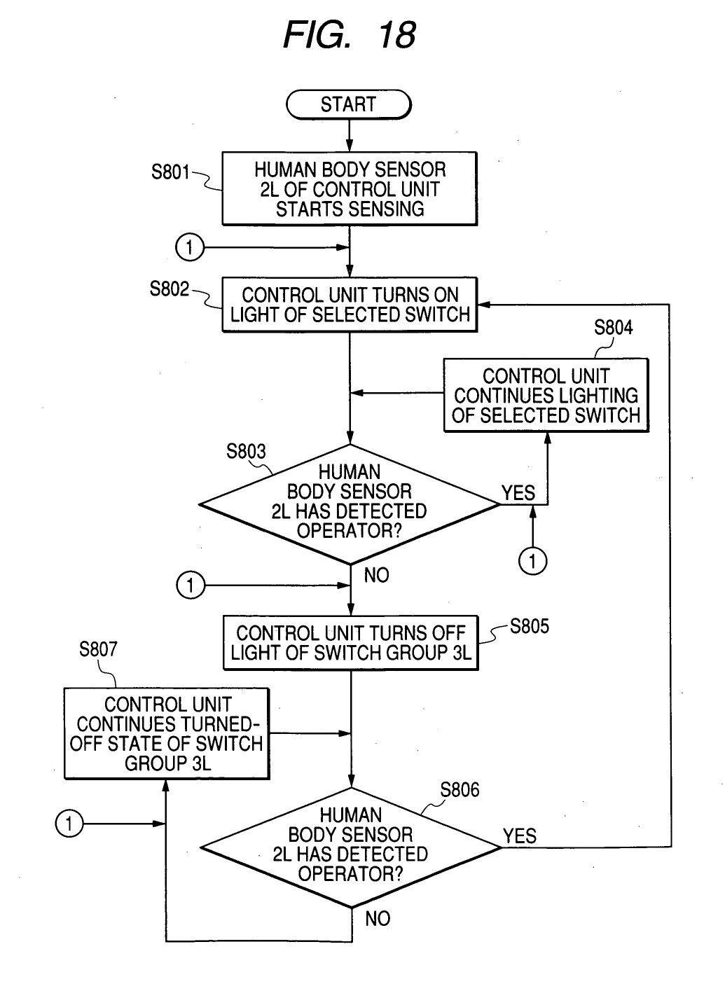

Here, a lighting control method for the left side switches will be described with reference to FIG. 18.

After the power-on of the apparatus, the left side human body sensor 2L starts sensing (S801) and turns on lights of switches designated by the information processing apparatus (S802). Then, when the left side human body sensor 2L has sensed a person, the control unit continues lighting of the left side switches (S803, S804). When the left side human body sensor 2L has not sensed a person, the control unit turns off the lights of the left side switches (S803, S805). This turned-off state is maintained until the left side human body sensor 2L senses a person (S806, S807). The same control is performed for the right side switches.

According to this example, only a light of a switch to which a function of software is allocated is turned on, and a switch to which the function of the software is not allocated is brought into a turned-off state or a darkened state, whereby it becomes possible to further reduce the risk that an operator makes any erroneous operation.

### EXAMPLE 4

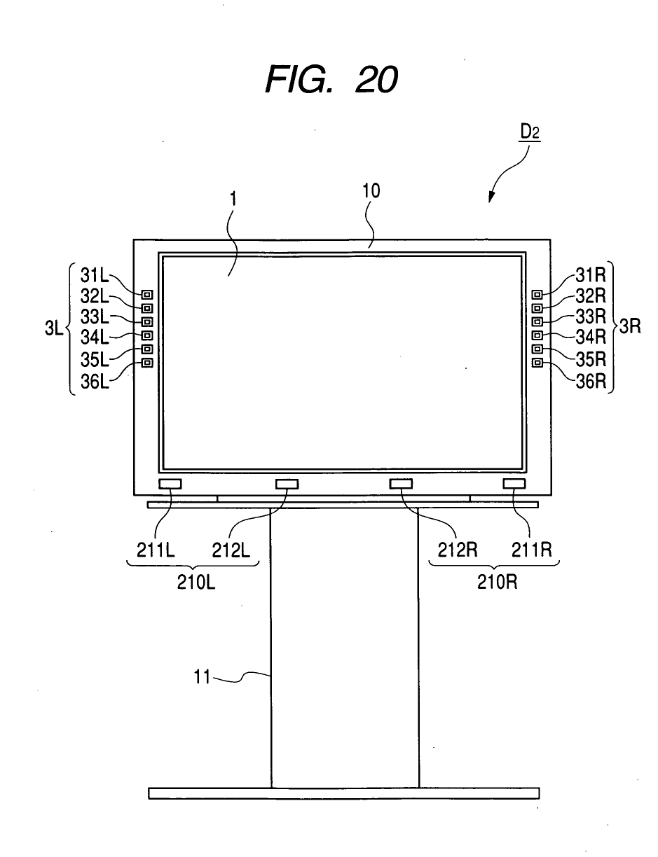

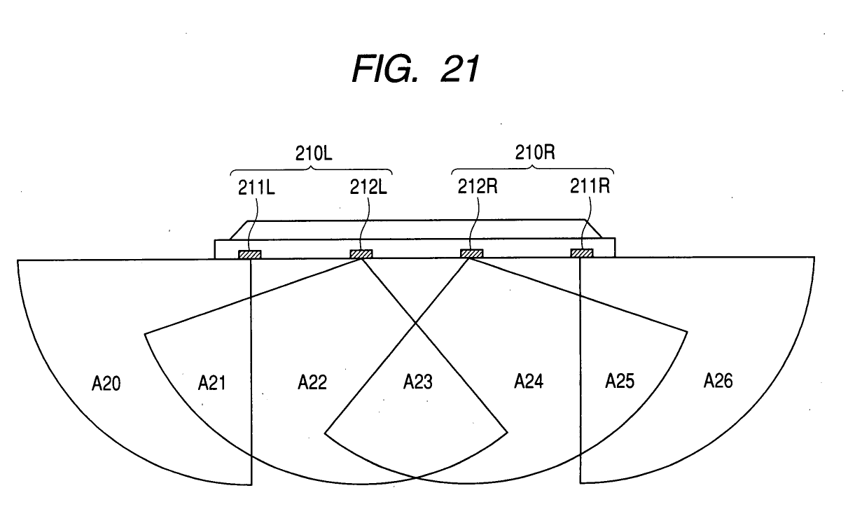

In this example, a display apparatus D₂ shown in FIG. 20 was manufactured. That is, four human body sensors 211L, 212L, 212R, and 211R were arranged below the image display section 1 such that

areas denoted by reference characters A20 and A21 of FIG. 21 were sensed by the human body sensor 211L on the outer left side,

areas denoted by reference characters A21, A22 and A23 of FIG. 21 were sensed by the human body sensor 212L on the inner left side,

areas denoted by reference characters A23, A24 and A25 of FIG. 21 were sensed by the human body sensor 212R on the inner right side, and

areas denoted by reference characters A25 and A26 in FIG. 21 were sensed by the human body sensor 211R on the outer right side. Other structures were the same as the display apparatus D₁ shown in FIG. 9.

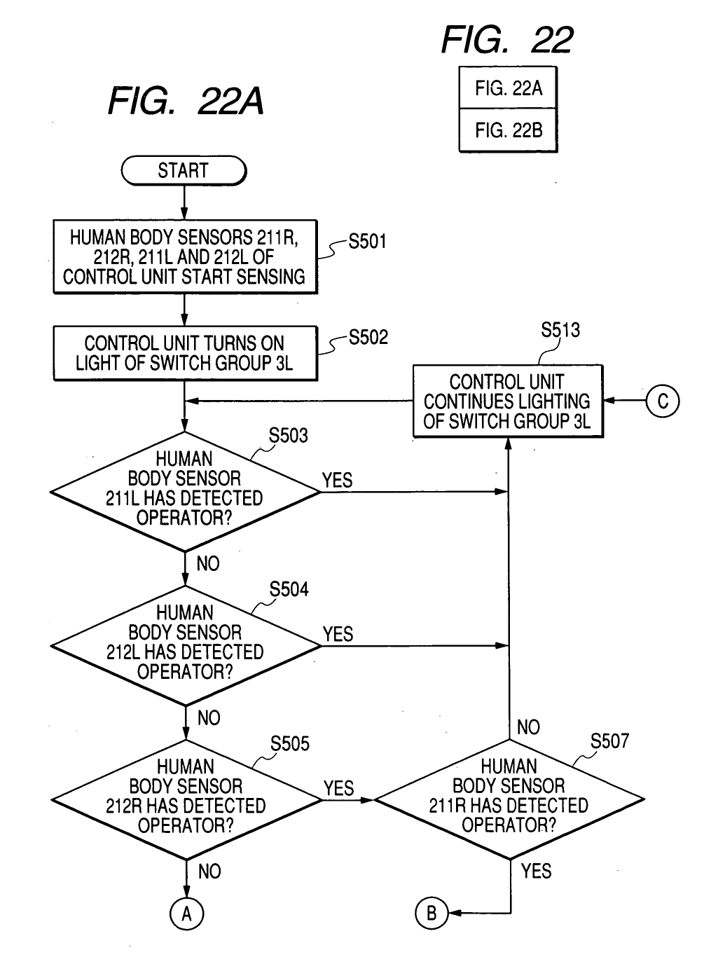

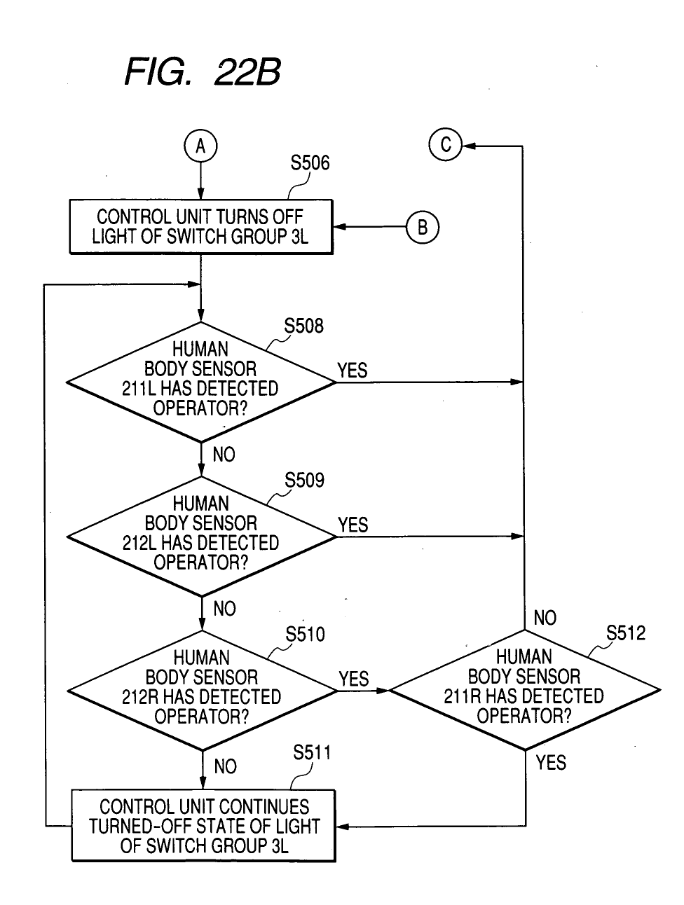

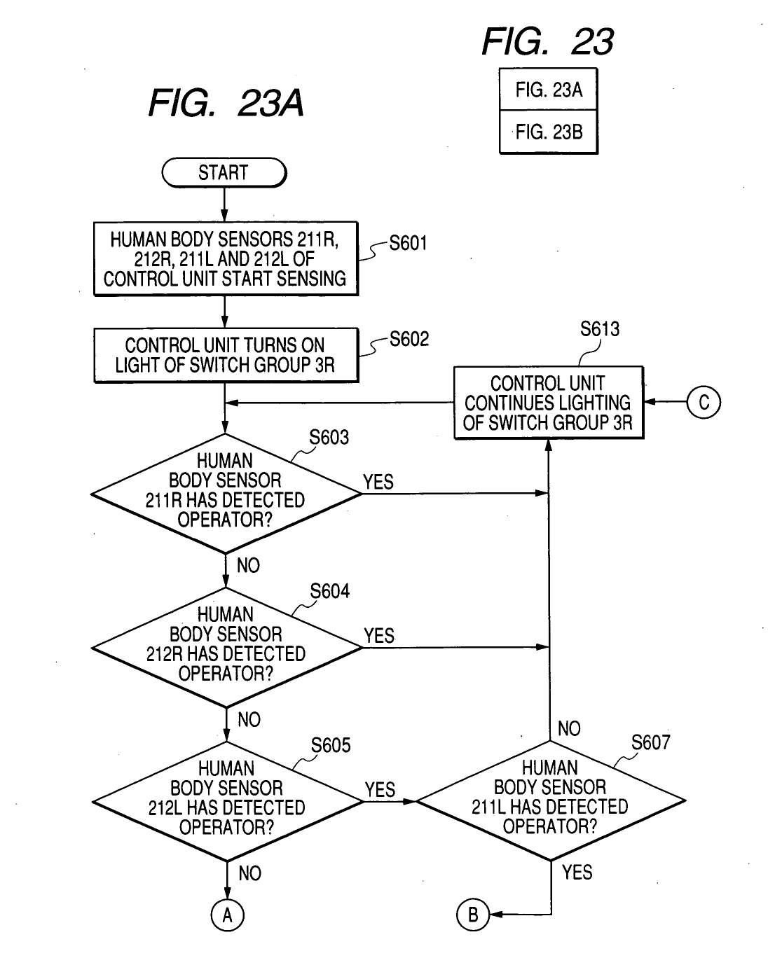

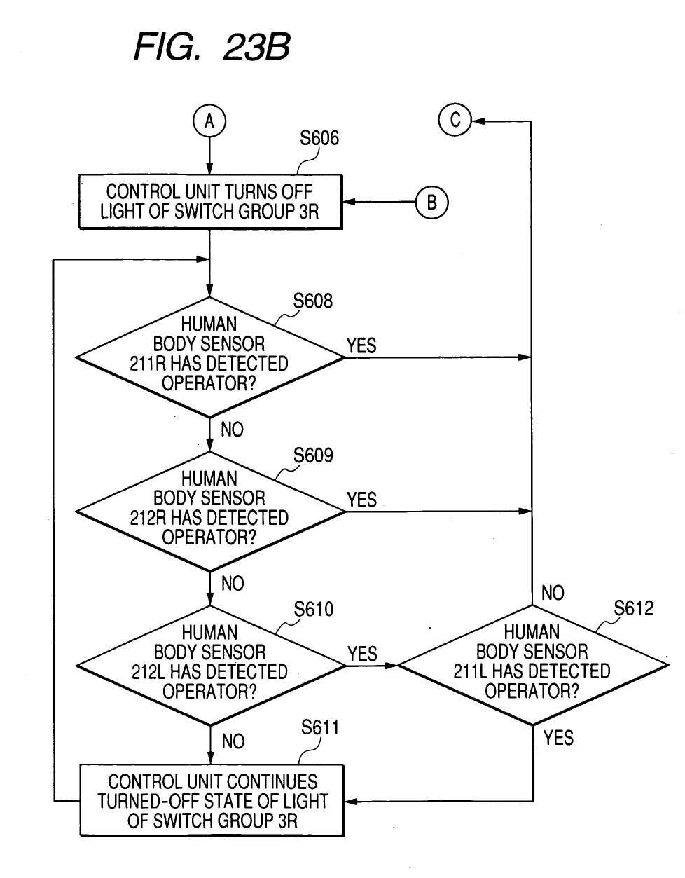

Referring to FIGS. 22A, 22B, 23A and 23B, lighting control for the left switches 31L, etc. and the right switches 31R, etc. will be hereinafter described.

After the power-on of the apparatus, all the human body sensors 211R, 212R, 211L and 212L start sensing in respective sensing areas (S501 in FIG. 22A), and the control unit turns on a light of the left side switch group 3L (regardless of presence or absence of a person) (S502). Next, the control unit judges whether or not a person exists there according to information from the human body sensor 211L on the outer left side (S503). If the human body sensor 211L has sensed a person, the control unit continues lighting of the left side switch group 3L (S513). Even if the human body sensor 211L has not sensed a person, when the human body sensor 212L on the inner left side has sensed a person, the control unit continues lighting of the left side switch group 3L (S504, S513). Then, in the case in which the human body sensor 211L on the outer left side and the human body sensor 212L on the inner left side are in an OFF state and the human body sensor 212R on the inner right side and the human body sensor 211R on the outer right side are in an ON state, the light of the left side switch group 3L is turned off. In the case in which the human body sensor 211L on the outer left side and the human body sensor 212L on the inner left side are in an OFF state and the human body sensor 212R on the inner right side is in an OFF state, the light of the left side switch group 3L is also turned off (S506).

In the case in which the control unit has turned off the light of the left side switch group 3L (S506), sensing by the human body sensors 211L, 212L, 212R, and 211R is continued (S508 to S512).

According to the above process, in the case in which a person exists in the areas A20 to A24, the light of the left side switch group 3L is turned on (see a table shown below).

TABLE 2

| Sensor | Sensor | Sensor | Sensor | | |
|---|---|---|---|---|---|
| 211L | 212L | 212R | 211R | | |
| on outer | on inner | on inner | on outer | | Left side |
| left side | left side | right side | right side | | switch |
| On | | | | A20, A21 | Turn on |
| | | | | | (S503, S513) |
| Off | On | | | A22, A23 | Turn on |
| | | | | | (S504, S513) |
| Off | Off | On | On | A24, | Turn off |
| | | | | A25, | (S505, S507, |
| | | | | A26 | S506) |
| Off | Off | On | Off | A24 | Turn on |
| | | | | | (S505, S507, |
| | | | | | S513) |

Next, all the human body sensors 211R, 212R, 211L and 212L start sensing in the respective sensing areas (S601 in FIG. 23A), and the control unit turns on a light of the right side switch group 3R (regardless of presence or absence of a person) (S602). Next, the control unit judges whether or not a person exists there according to information from the human body sensor 211R on the outer right side (S603). If the human body sensor 211R has sensed a person, the control unit continues lighting of the right side switch group 3R (S613). Even if the human body sensor 211R has not sensed a person, when the human body sensor 212R on the inner right side has sensed a person, the control unit continues lighting of the right side switch group 3R (S604, S613). Then, in the case in which the human body sensor 212R on the inner right side and the human body sensor 211R on the outer right side are in an OFF state and the human body sensor 211L on the outer left side and the human body sensor 212L on the inner left side are in an ON state, the light of the right side switch group 3R is turned off. In the case in which the human body sensor 212R on the inner right side and the human body sensor 211R on the outer right side are in an OFF state and the human body sensor 212L on the inner left side is in an OFF state, the light of the right side switch group 3R is also turned off (S606).

In the case in which the control unit has turned off the light of the right side switch group 3R (S606), sensing by the human body sensors 211L, 212L, 212R and 211R is continued (S608 to S612). According to the above process, in the case in which a person exists in the areas A22 to A26, the light of the right side switch group 3R is turned on (see a table shown below).

TABLE 3

| Sensor | Sensor | Sensor | Sensor | | |
|---|---|---|---|---|---|
| 211R | 212R | 212L | 211L | | |
| on outer | on inner | on inner | on outer | | Right side |
| right side | right side | left side | left side | | switch |
| On | | | | A25, A26 | Turn on |
| | | | | | (S603, S613) |
| Off | On | | | A23, A24 | Turn on |
| | | | | | (S604, S613) |
| Off | Off | On | On | A20, | Turn off |
| | | | | A21, | (S605, S607, |
| | | | | A22 | S606) |
| Off | Off | On | Off | A22 | Turn on |
| | | | | | (S605, S607, |
| | | | | | S613) |

According to the process of this example, in the case in which the control unit has judged that a person exists in the sensing areas A22, A23 and A24, the control unit judges that a plurality of persons exist or the person exists on a front side of the image display section 1, and lights of both the left side switch group 3L and the right side switch group 3R are turned on. In the case in which the control unit has judged that a person exists in the areas A20 and A21, only the light of the left side switch group 3L is turned on. In the case in which the control unit has judged that a person exists in the areas A25 and A26, only the light of the right side switch group 3R is turned on.

The same information processing apparatus as Example 3 may be connected to this display apparatus.

In addition, the four human body sensors are used in this example. It is needless to mention that the number of human body sensors is not limited to this, and three or five or more human body sensors may be used.

According to this example, the four human body sensors are used, whereby a position of a person can be judged accurately, and a lighting state of a switch group can be controlled finely.

As described above, according to the present embodiment, the switches are arranged on both the left side and the right side of the image display section, and principal operations can be executed by both the switches on the left side and the switches on the right side. Therefore, in the case in which presentation or the like is performed in the presence of others using this display apparatus, a presenter only has to operate the switches on the side close to the presenter and can be prevented from obstructing an image whether the presenter stands on the left side or the right side of the image display section.

As described above with reference to the embodiments and the examples, according to the present invention, the presenter can operate the switches without obstructing the image display section whether the presenter performs presentation on the left side or the right side of the display apparatus.

What is claimed is:

1. A display apparatus comprising: an image display section, a housing for supporting the image display section, and a switch arranged in the housing,
wherein the display apparatus includes a plurality of switches, and
wherein the plurality of switches have the same function as one another and are arranged on a left side and a right side with respect to the image display section.

2. A display apparatus according to claim 1, wherein the plurality of switches are arranged on a display surface side of the image display of the housing.

3. A display apparatus according to claim 2, wherein the plurality of switches are arranged on either one of an upper edge side and a lower edge side of the image display section.

4. A display apparatus according to claim 1, wherein the plurality of switches are arranged on a left edge side and a right edge side of the image display section, respectively.

5. A display apparatus according to claim 1, further comprising an object sensor.

6. A display apparatus according to claim 5, further comprising a judging means for bringing lights of ones of the plurality of switches into a turned-on state and lights of the others of the plurality of switches into a turned-off state according to a result of sensing by the object sensor.
